(19) United States
(12) Patent Application Publication
(10) Pub. No.: US 2017/0170865 A1
(43) Pub. Date: Jun. 15, 2017

(54) QUADPLEXER

(71) Applicant: SAMSUNG ELECTRO-MECHANICS CO., LTD., Suwon-si (KR)

(72) Inventor: Seong Jong CHEON, Suwon-si (KR)

(73) Assignee: SAMSUNG ELECTRO-MECHANICS CO., LTD., Suwon-si (KR)

(21) Appl. No.: 15/264,953

(22) Filed: Sep. 14, 2016

(30) Foreign Application Priority Data
Dec. 14, 2015 (KR) 10-2015-0178478

(51) Int. Cl. H04B 1/52; H04B 1/40; H04B 1/00

(52) U.S. Cl. CPC H04B 1/52; H04B 1/0057; H04B 1/006; H04B 1/40

(57) ABSTRACT

A quadplexer includes a duplexer circuit including a first duplexer configured to separate transfer paths of a transmission signal and a reception signal of a first frequency band respectively transmitted and received through a first signal line connected to a single antenna from each other, and, a second duplexer configured to separate transfer paths of a transmission signal and a reception signal of a second frequency band transmitted and received through a second signal line connected to the single antenna from each other; and, an impedance matcher disposed between the single antenna and the duplexer, and configured to change an impedance of at least one of: signal transmitting and receiving ends of the first duplexer and signal transmitting and receiving ends of the second duplexer by the impedance matching between the single antenna and at least one of the first signal line and the second signal line.

### CROSS-REFERENCE TO RELATED APPLICATION

This application claims the benefit of Korean Patent Application No. 10-2015-0178478, filed on Dec. 14, 2015 in the Korean Intellectual Property Office, the entire disclosure of which is incorporated herein by reference for all purposes.

### BACKGROUND

1. Field

The following description relates to a quadplexer transmitting and receiving signals in a set frequency band.

2. Description of Related Art

Recently, mobile communications systems tend to have more complicated functions in order to satisfy various customer demands.

In accordance with development of a portable terminal used in mobile communications systems, a quadplexer formed by modularizing two duplexers to be used in a front end module has been developed.

A quadplexer is a component used in a front end module in order to separate signals of two different frequency bands/modes of a portable terminal using multiple frequency bands.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a general aspect a quadplexer includes a duplexer circuit including a first duplexer configured to separate transfer paths of a transmission signal and a reception signal of a first frequency band respectively transmitted and received through a first signal line connected to a single antenna from each other, and, a second duplexer configured to separate transfer paths of a transmission signal and a reception signal of a second frequency band transmitted and received through a second signal line connected to the single antenna from each other; and, an impedance matcher disposed between the single antenna and the duplexer circuit, and configured to change an impedance of at least one of: signal transmitting and receiving ends of the first duplexer and signal transmitting and receiving ends of the second duplexer by the impedance matching between the single antenna and at least one of the first signal line and the second signal line.

The impedance matcher may be further configured to change an impedance to change a size of a concentric circle of the impedance trajectory formed in a Smith chart.

The impedance matcher may be further configured to set an inductance between the single antenna and the first signal line and an inductance between the single antenna and the second signal line to be different from each other.

The impedance matcher may include an impedance matching circuit connected to at least one of the first signal line and the second signal line.

The impedance matching circuit may include an inductor connected between one of the first signal line and the second signal line and a ground.

The impedance matcher may include impedance matching circuits respectively connected to the first signal line and the second signal line.

The impedance matching circuits may include a first inductor connected between the first signal line and a ground and a second inductor connected between the second signal line and the ground.

A frequency of a frequency band of signals transmitted and received through the first signal line may be higher than that of a frequency band of signals transmitted and received through the second signal line.

A frequency of a frequency band of signals transmitted and received through the first signal line may be higher than that of a frequency band of signals transmitted and received through the second signal line, and a level of an inductance of the first inductor is lower than that of an inductance of the second inductor.

According to another general aspect, a quadplexer includes a duplexer circuit including a first duplexer configured to separate transfer paths of a transmission signal and a reception signal of a first frequency band transmitted and received through a first signal line connected to a single antenna from each other, and, a second duplexer configured to separate transfer paths of a transmission signal and a reception signal of a second frequency band transmitted and received through a second signal line connected to the single antenna from each other; and, an impedance matcher disposed between the single antenna and the duplexer, and configured to change an impedance of at least one of: signal transmitting and receiving ends of the first duplexer and signal transmitting and receiving ends of the second duplexer depending on a ratio between inductances of the first signal line and the second signal line.

The impedance matcher may be further configured to change an impedance to change a size of a concentric circle of the impedance trajectory formed in a Smith chart.

The impedance matcher may include an inductor connected between at least one of the first signal line and the second signal line, and a ground.

The impedance matcher may include a first inductor connected between the first signal line and a ground and a second inductor connected between the second signal line and the ground.

A frequency of a frequency band of signals transmitted and received through the first signal line may be higher than that of a frequency band of signals transmitted and received through the second signal line.

A frequency of a frequency band of signals transmitted and received through the first signal line may be higher than that of a frequency band of signals transmitted and received through the second signal line, and a level of an inductance of the first inductor may be lower than that of an inductance of the second inductor.

Other features and aspects will be apparent from the following detailed description, the drawings, and the claims.

### BRIEF DESCRIPTION OF DRAWINGS

FIG. 1 is a schematic block diagram of a quadplexer according to an embodiment.

FIG. 2 is a schematic circuit diagram of a quadplexer according to an embodiment.

FIG. 3 is a schematic circuit diagram of a quadplexer according to an embodiment.

FIG. 4 is an example Smith chart of a general quadplexer, and FIG. 5 is a Smith chart of a quadplexer according to an embodiment.

FIG. 6A is an example graph illustrating frequency response characteristics of a general quadplexer, and FIG. 6B is a graph illustrating frequency response characteristics of a quadplexer according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

The following description may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there are no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” than the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

In the drawings, for example, due to manufacturing techniques and/or tolerances, modifications of the shape shown may be estimated. Thus, embodiments of the present disclosure should not be construed as being limited to the particular shapes of regions shown herein, but should be understood to include, for example, a change in shape resulting from manufacturing. The following embodiments may also be constituted by one or a combination thereof.

The contents of the present disclosure described below may have a variety of configurations, but are not limited thereto.

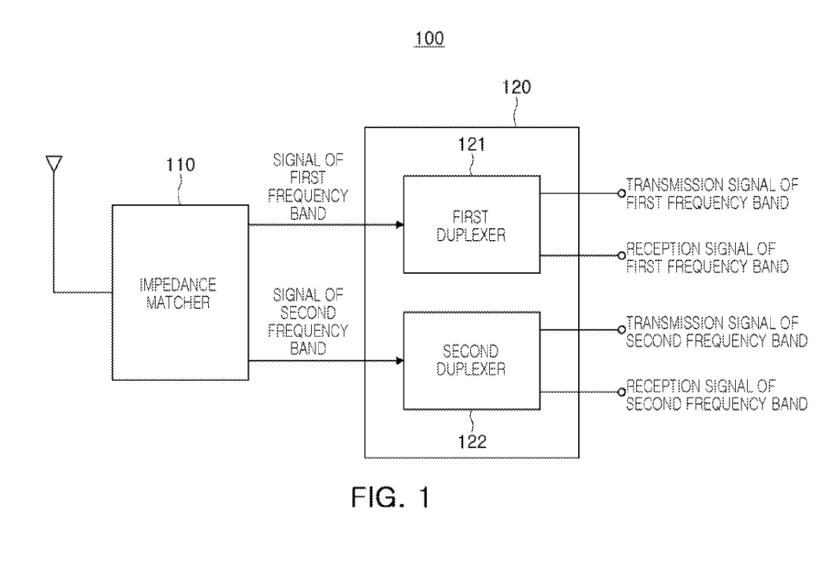

FIG. 1 is a schematic block diagram of a quadplexer according to an embodiment.

A general quadplexer has been developed in a scheme of combining a low frequency band, an intermediate frequency band, and a high frequency band in mobile communications systems with each other one by one to be separated into four transmission and reception signals. However, due to the introduction of a carrier aggregation (CA) scheme, a quadplexer for a combination between adjacent frequency bands such as a combination between low frequency bands, a combination between an intermediate frequency band and a high frequency band, or the like, would be beneficial.

A quadplexer in the related art has been implemented using two duplexers and a diplexer, or has been implemented using a phase shift network. However, in such a case, frequency response and insertion loss performance is deteriorated in a quadplexer adopting a combination between adjacent frequency bands.

Referring to FIG. 1, a quadplexer 100 according to an embodiment includes an impedance matcher 110 and a duplexer 120.

The impedance matcher 110 separates signals transmitted and received through a single antenna into signals of a first frequency band and signals of a second frequency band.

According to an embodiment, the first frequency band and the second frequency band are frequency bands adjacent to each other. For example, the first frequency band and the second frequency band are low frequency bands or high frequency bands of which use frequencies are adjacent to each other, or the first frequency band is a high frequency band and the second frequency band is an intermediate frequency band.

In order to smoothly perform transmission and reception of the signals of the first frequency band and the signals of the second frequency band described above, impedance matching of signal transmitting and receiving ends of the first frequency band and signal transmitting and receiving ends of the second frequency band are performed.

The impedance matching described above is performed by the impedance matcher 110.

In addition, the impedance matcher 110 changes an impedance of at least one of signal transmitting and receiving ends of a first duplexer and signal transmitting and receiving ends of a second duplexer when the impedance matching is performed.

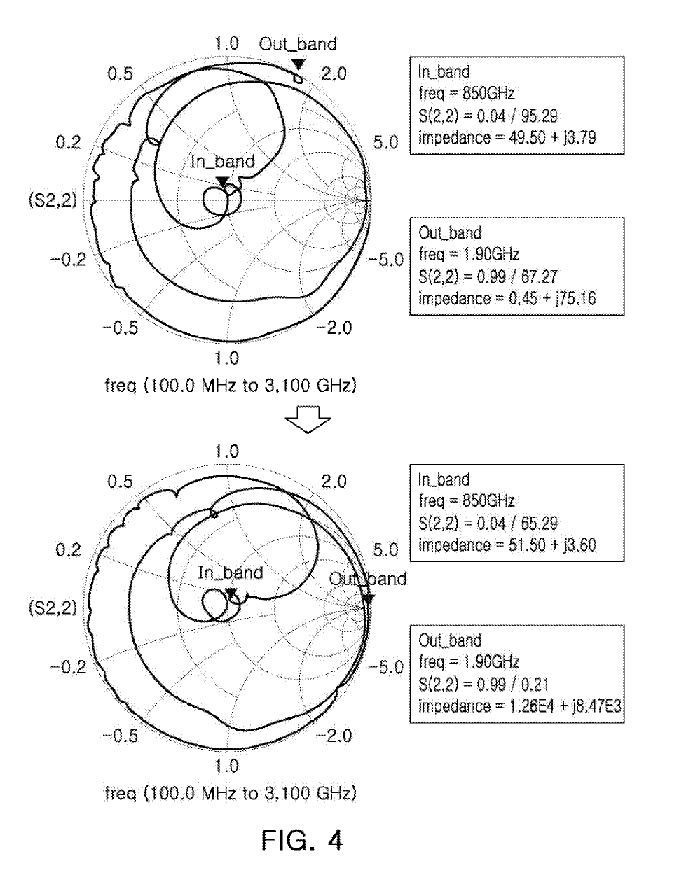

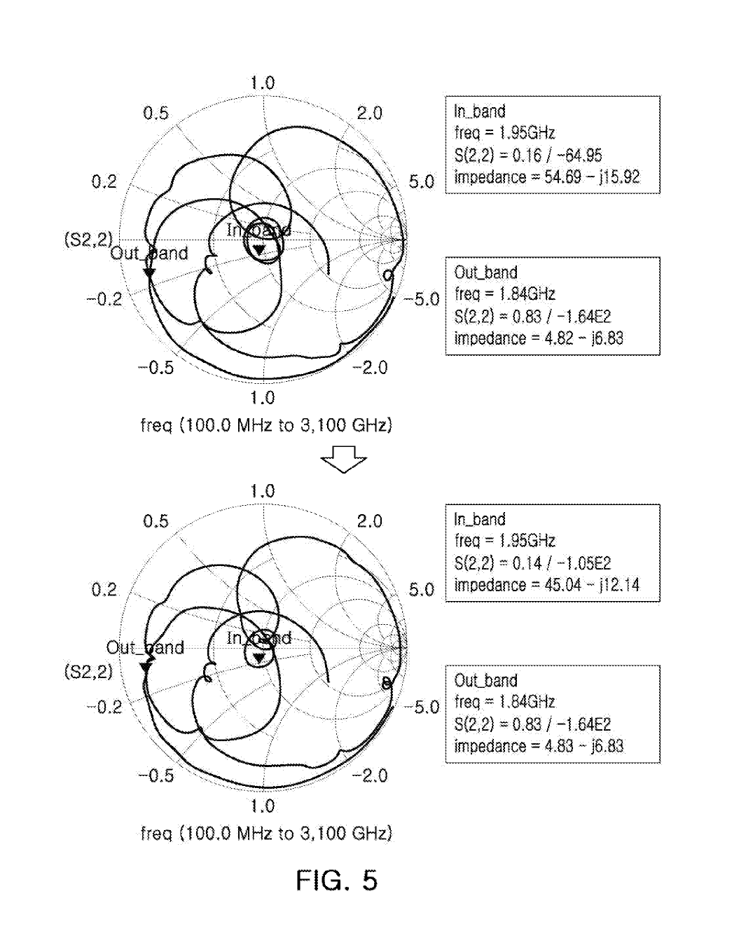

In this regard, a further description is provided below with reference to FIGS. 4 through 6B.

Next, the duplexer 120 separates paths of transmission signals and reception signals of the first frequency band from each other, and separates paths of transmission signals and reception signals of the second frequency band from each other.

To this end, the duplexer 120 includes a first duplexer 121 and a second duplexer 122.

The first duplexer 121 separates the paths of the transmission signals and the reception signals of the first frequency band from each other, and the second duplexer 122 separates the paths of the transmission signals and the reception signals of the second frequency band from each other.

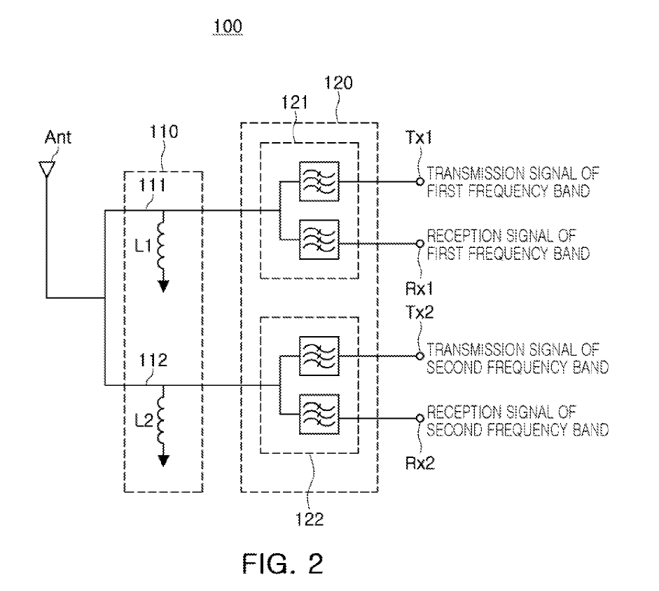

FIG. 2 is a schematic circuit diagram of the quadplexer according to an embodiment.

Referring to FIG. 2 together with FIG. 1, the quadplexer 100 according to an embodiment includes the impedance matcher 110 and the duplexer 120.

The impedance matcher 110 is disposed between the single antenna Ant and the duplexer 120.

For example, the impedance matcher 110 includes impedance matching circuits each connected to a first signal line 111 and a second signal line 112. The impedance matching circuits set an impedance between the antenna and the first signal line 111 and an impedance between the antenna and the second signal line 112 to be different from each other.

For example, the impedance matching circuits include inductors L1 and L2, respectively.

A first inductor L1 is connected between the first signal line 111 and a ground, and a second inductor L2 is connected between the second signal line 112 and the ground.

For example, an inductance of the first inductor L1 and an inductance of the second inductor L2 are set to be different from each other.

For example, in a case in which a frequency band of signals of a first frequency band transmitted and received through the first signal line 111 is higher than that of signals of a second frequency band transmitted and received through the second signal line 112, the inductance of the first inductor L1 is lower than that of the second inductor L2.

According to an embodiment, the first or second inductor L1 or L2 of the impedance matcher 110 serves as a phase shift network for impedance open matching of signal transmitting and receiving ends Rx1, Tx1, Rx2, and Tx2 in the first or second frequency band.

For example, in a case in which a frequency of the first frequency band is higher than that of the second frequency band, the inductance of the first inductor L1 is set to be lower than that of the second inductor L2.

A relationship between the frequency and the inductance described above is further described below. A length of a transmission line of ¼ wavelength is in proportion to an inductance of an inductor connected to a ground, and a frequency and the length of the transmission line of ¼ wavelength has an inverse number relationship therebetween. Therefore, the inductance of the first inductor L1 having the first frequency band, which is a high frequency band, is lower than that of the second inductor L2.

In addition, a ratio between the inductance of the first inductor L1 and the inductance of the second inductor L2 is set depending on the frequency of the first frequency band and the frequency of the second frequency band. For example, in a case in which the first frequency band has a center frequency of 1.95 GHz and the second frequency band has a center frequency of 1.84 GHz, the ratio between the inductance of the first inductor L1 and the inductance of the second inductor L2 may be set to approximately 1:1.3 to 1:2.

The duplexer 120 includes the first and second duplexers 121 and 122. Each of the first and second duplexers 121 and 122 include two band pass filters to separate transfer paths of the transmission signals and the reception signal of the first frequency band from each other and separate transfer paths of the transmission signals and the reception signal of the second frequency band from each other respectively.

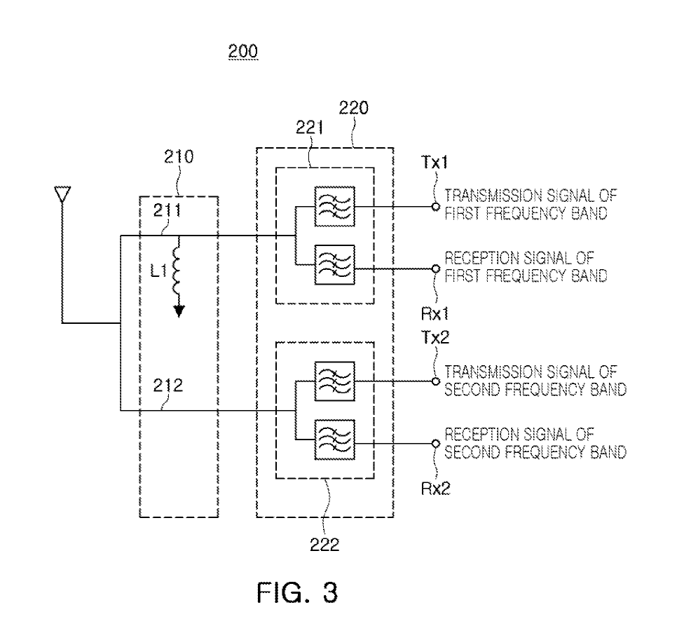

FIG. 3 is a schematic circuit diagram of a quadplexer according to another embodiment in the present disclosure.

Referring to FIG. 3, a quadplexer 200 according to another embodiment includes an impedance matcher 210 and a duplexer 220.

Since a configuration and an operation of the duplexer 220 are the substantially similar to those of the duplexer 120 illustrated in FIG. 2, a detailed description thereof will be omitted here for clarity and brevity.

The impedance matcher 210 includes a first signal line 211 and a second signal line 212. An impedance matching circuit is connected to one of the first signal line 211 and the second signal line 212.

The impedance matching circuit includes an inductor L1.

The inductor L1 is connected between one of the first signal line 211 and the second signal line 212 and a ground.

In a case in which a frequency of a frequency band of signals of a first frequency band transferred through the first signal line 211 is higher than that of a frequency band of signals of a second frequency band transferred through the second signal line 212, the inductor L1 is connected between the first signal line 211 and the ground.

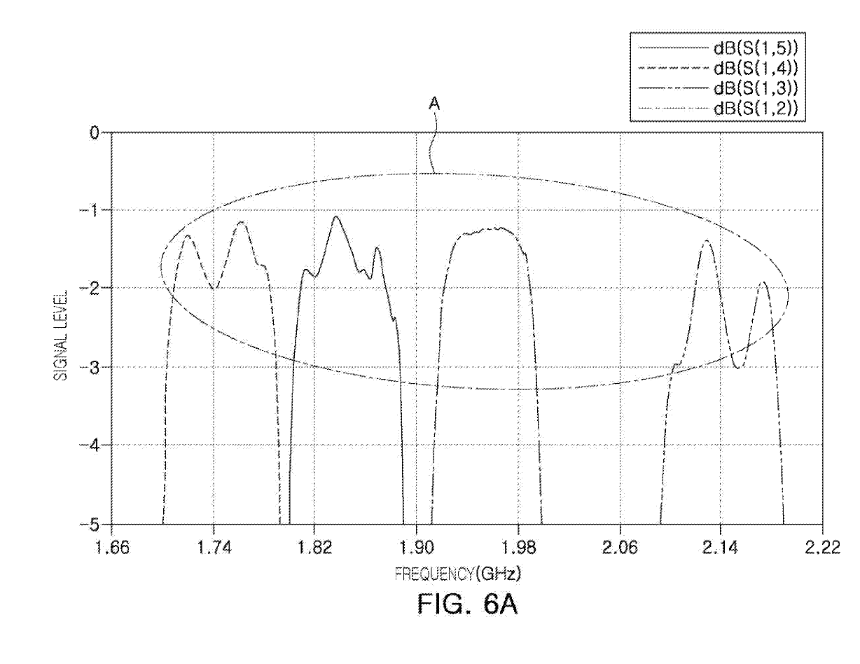

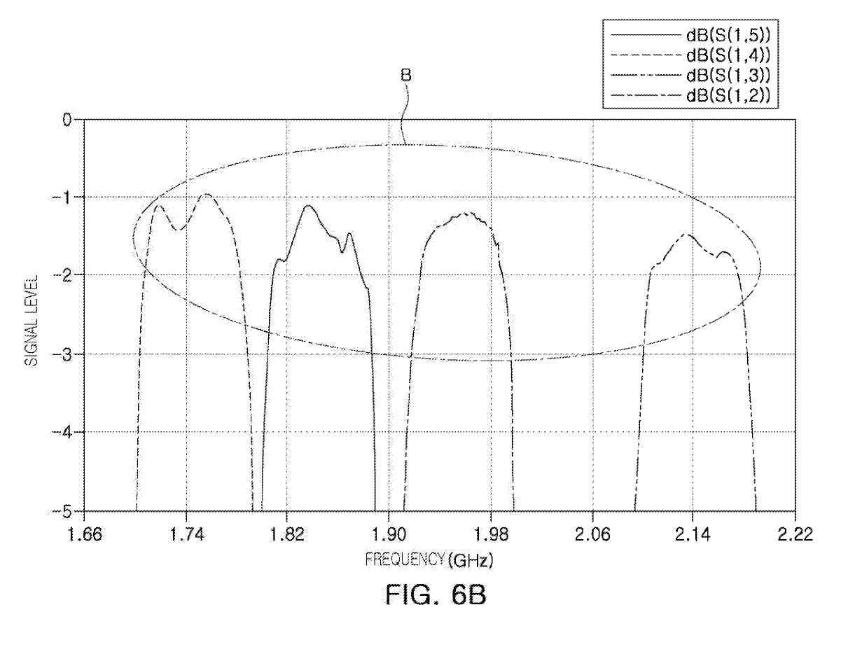

FIG. 4 is a Smith chart of a general quadplexer, FIG. 5 is a Smith chart of a quadplexer according to an embodiment, FIG. 6A is a graph illustrating frequency response characteristics of a general quadplexer, and FIG. 6B is a graph illustrating frequency response characteristics of a quadplexer according to an embodiment.

First, referring to FIG. 4, a general quadplexer includes a diplexer circuit or a phase shift network between an antenna and a duplexer. The general quadplexer described above may only be effective in a case in which a wide frequency band spacing of about 500 MHz or more, between a first frequency band and a second frequency band is maintained, but a problem such as insertion loss deterioration, or the like, may be caused in a quadplexer in which a frequency band spaced between a first frequency band and a second frequency band is a narrow band less than about 100 MHz.

In the general quadplexer described above, in a case in which a center frequency In_band of the first frequency band is set to 850 MHz and a center frequency Out_band of the second frequency band is set to 1.9 GHz, impedance matching is performed from a Smith chart of an upper end of FIG. 4 to a Smith chart of a lower end of FIG. 4 by the diplexer circuit or the phase shift network described above. It is seen in FIG. 4 that in impedance trajectories of the Smith charts of the upper end and the lower end of FIG. 4, only a phase is changed in relation to 50 ohms, which is a characteristic impedance, without a change in a size of a concentric circle.

In the general quadplexer described above, in a case in which the first frequency band and the second frequency band are adjacent to each other, it is difficult to secure an impedance close to infinity in any one of the first frequency band and the second frequency band, and thus frequency insertion loss is likely to occur. That is, for example, in a case in which a center frequency of the first frequency band is set to 1.95 GHz and a center frequency of the second frequency band is set to 1.84 GHz, transmission signals and reception signals of the first and second frequency bands are present. For example, a frequency band of the transmission signal of the first frequency band is set to 1.92 GHz to 1.98 GHz, a frequency band of the reception signal of the first frequency band is set to 2.11 GHz to 2.17 GHz, a frequency band of the transmission signal of the second frequency band is set to 1.71 GHz to 1.785 GHz, and a frequency band of the reception signal of the second frequency band is set to 1.805 GHz to 1.88 GHz, and it is seen that frequency response characteristics (insertion loss) are deteriorated as illustrated in a reference region A of FIG. 6A.

On the other hand, referring to FIG. 5, in the quadplexer according to an embodiment in the present disclosure, in a case in which a center frequency In_band of the first frequency band is set to 1.95 GHz and a center frequency Out_band of the second frequency band is set to 1.84 GHz, when reviewing an impedance trajectory of a Smith chart of an upper end of FIG. 5 and an impedance trajectory of a Smith chart of a lower end of FIG. 5, it is seen that a size of a concentric circle of the impedance trajectory is changed at the time of impedance matching.

That is, a size of a concentric circle of an impedance trajectory is changed depending on a ratio between the inductances of the first inductor L1 and the second inductor L2 of the impedance matcher 110 or 210 of FIGS. 1 through 3 at the time of impedance matching of signal transmitting and receiving ends Tx1 and Rx1 of the first duplexer 121 or 221 and signal transmitting and receiving ends Tx2 and Rx2 of the second duplexer 122 or 222. Therefore, frequency response characteristics of the signals of the first frequency band and the signals of the second frequency band of which used frequencies are adjacent to each other are nonetheless still good, in other words, exhibit suitable frequency response and insertion loss as seen, for example, in the comparison of FIGS. 6A and 6B.

Referring to FIG. 6B, it may be seen that, for example, in a case in which a frequency band of the transmission signal of the first frequency band is set to 1.92 GHz to 1.98 GHz, a frequency band of the reception signal of the first frequency band is set to 2.11 GHz to 2.17 GHz, a frequency band of the transmission signal of the second frequency band is set to 1.71 GHz to 1.785 GHz, a frequency band of the reception signal of the second frequency band is set to 1.805 GHz to 1.88 GHz, and frequency response characteristics (insertion loss) of the transmission and reception signals of the first frequency band and the transmission and reception signals of the second frequency band are good in corresponding frequency bands, as illustrated in a reference region B of FIG. 6B.

As described above, according to an embodiment, in one transceiver processing the transmission and reception signals of the first and second frequency bands of which the frequencies are adjacent to each other through the single antenna, the deterioration of the frequency response and insertion loss may be prevented or substantially reduced, and narrow band frequency separation (of e.g. less than about 500 MHz or less than about 100 MHz) may be more readily performed.

The apparatuses, units, modules, devices, controllers, impedance matchers, and other components illustrated in FIGS. 1-3 that perform the operations described herein with respect to FIGS. 4-6B are implemented by hardware components. In some embodiments, impedance values may be established in static manner during fabrication. In other embodiments, impedance values in the impedance matcher for the first and second frequency bands may be dynamically established by various hardware components. Examples of hardware components include controllers, sensors, generators, drivers, inductors, resistors, capacitors, logic, and any other electronic components known to one of ordinary skill in the art. In one example, the hardware components are implemented by one or more processor portions or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 4-6B. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 4-6B that perform the operations described herein may be performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art, after gaining a thorough understanding of the present disclosure, can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

As set forth above, according to an embodiment, the deterioration of the frequency response and insertion loss may be substantially suppressed.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A quadplexer comprising:
a duplexer circuit comprising a first duplexer configured to separate transfer paths of a transmission signal and a reception signal of a first frequency band respectively transmitted and received through a first signal line connected to a single antenna from each other, and, a second duplexer configured to separate transfer paths of a transmission signal and a reception signal of a second frequency band respectively transmitted and received through a second signal line connected to the single antenna from each other; and,
an impedance matcher disposed between the single antenna and the duplexer circuit, and configured to change an impedance of at least one of signal transmitting and receiving ends of the first duplexer or signal transmitting and receiving ends of the second duplexer by the impedance matching between the single antenna and at least one of the first signal line or the second signal line.

2. The quadplexer of claim 1, wherein the impedance matcher is further configured to change an impedance to change a size of a concentric circle of the impedance trajectory formed in a Smith chart.

3. The quadplexer of claim 1, wherein the impedance matcher is further configured to set an inductance between the single antenna and the first signal line and an inductance between the single antenna and the second signal line to be different from each other.

4. The quadplexer of claim 1, wherein the impedance matcher comprises an impedance matching circuit connected to at least one of the first signal line or the second signal line.

5. The quadplexer of claim 4, wherein the impedance matching circuit comprises an inductor connected between one of the first signal line or the second signal line, and a ground.

6. The quadplexer of claim 1, wherein the impedance matcher comprises impedance matching circuits respectively connected to the first signal line and the second signal line.

7. The quadplexer of claim 6, wherein the impedance matching circuits comprise a first inductor connected between the first signal line and a ground and a second inductor connected between the second signal line and the ground.

8. The quadplexer of claim 5, wherein a frequency of a frequency band of signals transmitted and received through the first signal line is higher than that of a frequency band of signals transmitted and received through the second signal line.

9. The quadplexer of claim 7, wherein a frequency of a frequency band of signals transmitted and received through the first signal line is higher than that of a frequency band of signals transmitted and received through the second signal line, and
a level of an inductance of the first inductor is lower than that of an inductance of the second inductor.

10. A quadplexer comprising:
a duplexer circuit comprising a first duplexer configured to separate transfer paths of a transmission signal and a reception signal of a first frequency band respectively transmitted and received through a first signal line connected to a single antenna from each other, and, a second duplexer configured to separate transfer paths of a transmission signal and a reception signal of a second frequency band respectively transmitted and received through a second signal line connected to the single antenna from each other; and,
an impedance matcher disposed between the single antenna and the duplexer, and configured to change an impedance of at least one of signal transmitting and receiving ends of the first duplexer or signal transmitting and receiving ends of the second duplexer depending on a ratio between inductances of the first signal line and the second signal line.

11. The quadplexer of claim 10, wherein the impedance matcher is further configured to change an impedance to change a size of a concentric circle of the impedance trajectory formed in a Smith chart.

12. The quadplexer of claim 10, wherein the impedance matcher comprises an inductor connected between at least one of the first signal line or the second signal line, and a ground.

13. The quadplexer of claim 10, wherein the impedance matcher comprises a first inductor connected between the first signal line and a ground and a second inductor connected between the second signal line and the ground.

14. The quadplexer of claim 12, wherein a frequency of a frequency band of signals transmitted and received through the first signal line is higher than that of a frequency band of signals transmitted and received through the second signal line.

15. The quadplexer of claim 13, wherein a frequency of a frequency band of signals transmitted and received through the first signal line is higher than that of a frequency band of signals transmitted and received through the second signal line, and
a level of an inductance of the first inductor is lower than that of an inductance of the second inductor
